(19) United States
(12) Patent Application Publication
(10) Pub. No.: US 2019/0087391 A1
(43) Pub. Date: Mar. 21, 2019

(54) HUMAN-MACHINE INTERFACE FOR COLLABORATIVE SUMMARIZATION OF GROUP CONVERSATIONS

(71) Applicant: MICROSOFT TECHNOLOGY LICENSING, LLC, Redmond, WA (US)

(72) Inventors: Justin B. CRANSHAW, Seattle, WA (US); Amy X. ZHANG, Cambridge, MA (US)

(21) Appl. No.: 15/820,220

(22) Filed: Nov. 21, 2017

Related U.S. Application Data
(60) Provisional application No. 62/560,087, filed on Sep. 18, 2017.

(51) Int. Cl. G06F 17/22; G06F 3/0482; G06F 17/21; G06F 17/27; G06F 3/0481

(52) U.S. Cl. CPC G06F 17/2264; G06F 3/0482; G06F 3/04817; G06F 17/2785; G06F 17/218

(57) ABSTRACT

Technologies are disclosed for providing an improved human-machine interface for collaborative summarization of group conversations. The human-machine interface presents a group conversation. User input, such as a sequence of keystrokes or the selection of a graphic image, is received via the human-machine interface labeling an excerpt of the group conversation with a discourse act note corresponding to a discourse act. The discourse act note indicates that the excerpt specifies an action, an answer, a decision, an idea, a question, or another type of discourse act. The excerpt and the discourse act note are added to a summary of the group conversation. User input can also be received requesting to view the summary of the group conversation. In response thereto, the summary of the group conversation can be presented in the human-machine interface. The excerpts presented in the summary of the group conversation can be grouped by corresponding discourse acts.

### CROSS-REFERENCE TO RELATED APPLICATIONS

This application claims the benefit of U.S. Provisional Patent Application No. 62/560,087, entitled “HUMAN-MACHINE INTERFACE FOR COLLABORATIVE SUMMARIZATION OF GROUP CONVERSATIONS,” which was filed on Sep. 18, 2017, and which is expressly incorporated by reference herein in its entirety.

### BACKGROUND

Group conversation applications have seen considerable growth in popularity in recent years, especially for coordinating information work. By enabling quick, team-wide message exchange in public channels, these applications promise to minimize the frictions of group communication, particularly for distributed and remote teams. Many organizations make use of group conversation applications, such as the SLACK, HIPCHAT, INTERNET RELAY CHAT (“IRC”), and GOOGLE HANGOUTS CHAT group conversation applications to make decisions, answer questions, troubleshoot problems, and coordinate activity.

While frequently providing significant benefits such as those described above, group conversation applications also have attributes that lead to technical problems with these applications. For example, unlike email or discussion forums, group conversations are predominantly synchronous, with a higher expectation for quick responses and greater volume of back-and-forth messages exchanged in rapid succession. Group conversations also lack functionality for creating conversational structure, such as threading, instead opting for a long continuous stream of discussion.

These attributes can make it very difficult to find information of interest in old group conversations. These attributes can also make it difficult for a user to “catch up” when the user is not present for a group conversation. These challenges are significantly exacerbated when the conversations are fragmented across a multitude of group conversation channels. Consequently, some users of group conversation applications have described feeling overwhelmed and unable to keep up with the demands of their group conversation and the “always on” culture it creates.

For at least some of the reasons described above, current group conversation applications can also result in a significant use of computing resources. For example, and without limitation, the significant amount of time required for a user to “catch up” with a group conversation can result in inefficient use of computing resources, such as processor cycles, memory utilization, and power. Moreover, a significant amount of data can be transferred over a network while a user catches up with a group conversation, thereby negatively impacting network performance.

It is with respect to these and other considerations that the disclosure made herein is presented.

### SUMMARY

Technologies are described herein that provide an improved human-machine interface for collaborative summarization of group conversations. Through implementations of the technologies disclosed herein, an improved human-machine interface can be provided that allows participants in a group conversation to collectively annotate portions of a group conversation without leaving the group conversation.

Through implementations of the disclosed technologies, at least some of the technical problems associated with previous group conversation applications can be eliminated. For example, and without limitation, using the human-machine interface disclosed herein, a user can more quickly and easily catch up with subject matter of a previous group conversation. This can reduce the utilization of processor cycles, memory, power, and network bandwidth as compared to previous group conversation applications. Other technical benefits can also be realized through an implementation of the technologies disclosed herein.

According to one configuration disclosed herein, a human-machine interface, such as a graphical user interface (“GUI”), presents a group conversation. User input, such as a sequence of keystrokes or the selection of a graphic image, is received via the human-machine interface that labels an excerpt of the group conversation with a “discourse act note.” An excerpt of a group conversation is a continuous block of the conversation defined by a specified start and end. A discourse act note specifies the type of discourse taking place between participants in a group conversation within an excerpt of the group conversation. For example, and without limitation, a discourse act note can indicate that an excerpt (e.g. a sentence or paragraph) of a group conversation includes a question. Another discourse act note can indicate that an excerpt from the group conversation includes an answer to the previously-posed question.

An excerpt of a group conversation can be labeled with a discourse act note prior to or following receipt of the excerpt. As an example, a discourse act note for labeling the start of an excerpt of a group conversation can be received prior to the actual discourse in the excerpt taking place. Another discourse act note can be received after the excerpt or conversation has concluded that labels the end of the excerpt. Other types of discourse act notes can also be specified. For example, and without limitation, discourse act notes can indicate that an excerpt of a group conversation specifies an action, an answer, a decision, an idea, a question, or another type of discourse act.

When a user (who might also be referred to herein as a “participant”) in a group conversation labels an excerpt of the group conversation with its associated discourse act, the discourse act notes and excerpt are added to a running summary of the group conversation. Excerpts of the group conversation that have been labeled with discourse act notes are collected added to the summary. The summary can be presented directly in the group conversation or in another location. The excerpts of the group conversation presented in the summary can be grouped by discourse act. Discourse act notes 122 in the summary can also be linked to their proper place in the original group conversation.

The summary of a group conversation can also be edited, referenced, or sent to a second group conversation. A user can also subscribe to receive group summaries associated with a channel, subscribe to group summaries from a participant in a channel, or subscribe to group summaries associated with a topic.

It should be appreciated that the above-described subject matter can be implemented as a computer-controlled apparatus, a computer process, a computing system, or as an article of manufacture such as a computer readable medium. These and various other features will be apparent from a reading of the following Detailed Description and a review of the associated drawings.

This Summary is provided to introduce aspects of the disclosure presented herein in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a network architecture diagram showing aspects of a system for providing an improved human-machine interface for collaborative summarization of group conversations, according to one configuration;

FIG. 1B is a user interface diagram showing aspects of an excerpt of a group conversation that has been labeled with discourse act notes, in one configuration;

FIGS. 2A-2G are user interface diagrams showing aspects of an improved human-machine interface for collaborative summarization of group conversations, according to one configuration disclosed herein;

FIG. 3 is a flow diagram showing a routine that illustrates aspects of the operation of the computing devices shown in FIG. 1 for providing an improved human-machine interface for collaborative summarization of group conversations, according to one configuration disclosed herein;

FIG. 4 is a computer architecture diagram showing an illustrative computer hardware and software architecture for a computing system, such as the computing devices shown in FIG. 1, that can implement aspects of the technologies presented herein;

FIG. 5 is a network diagram illustrating a distributed computing environment capable of implementing aspects of the technologies presented herein; and

FIG. 6 is a computer architecture diagram illustrating a computing device architecture for a computing device, such as the computing devices shown in FIG. 1, that can implement aspects of the technologies presented herein.

### DETAILED DESCRIPTION

The following detailed description is directed to technologies for providing an improved human-machine interface for collaborative summarization of group conversations using in-situ annotations. As discussed briefly above, through an implementation of the technologies disclosed herein, the utilization of processor cycles, memory, network bandwidth, and other computing resources can be reduced as compared to previous group conversation applications, thereby improving the operation of the computing systems used to execute the applications. Other technical benefits can also be realized through an implementation of the technologies disclosed herein.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for providing an improved human-machine interface for collaborative summarization of group conversations will be described.

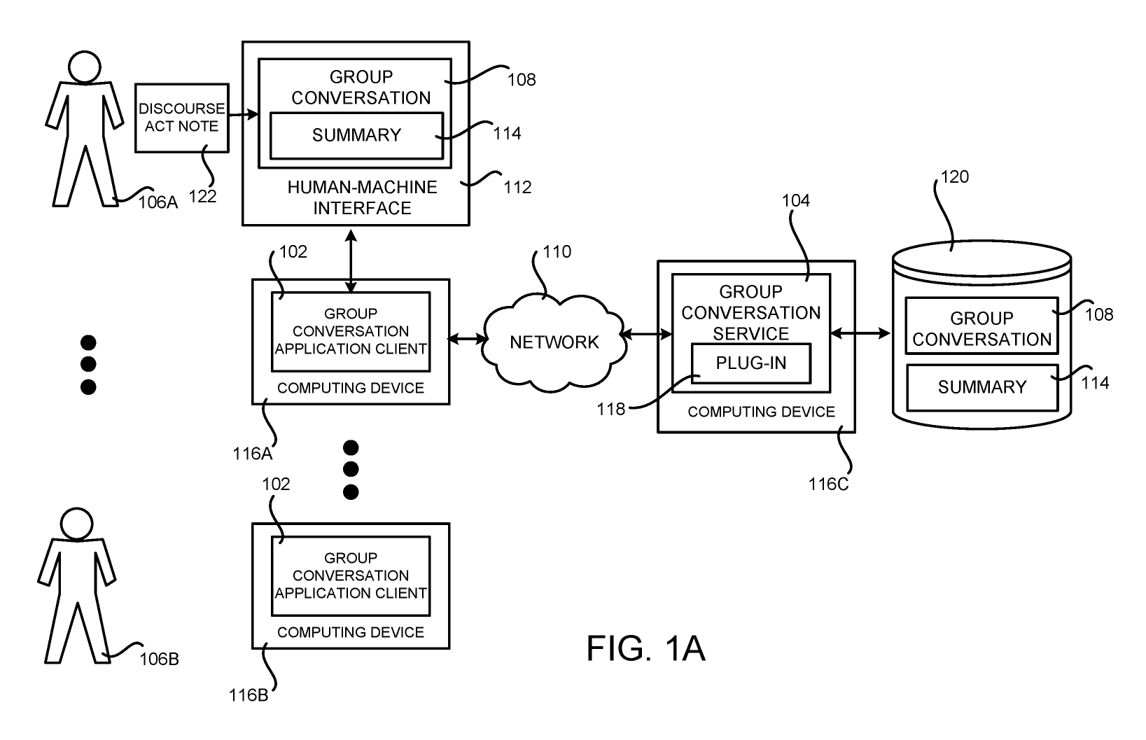

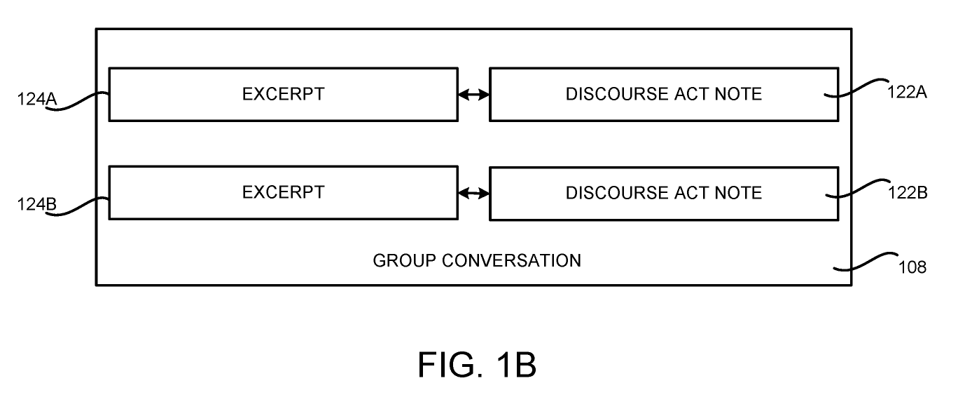

FIG. 1A is a network architecture diagram showing aspects of a system for providing a human-machine interface for collaborative summarization of group conversations, according to one configuration. As shown in FIG. 1A, a group conversation application client 102 (which might be referred to herein as “the client 102”) can execute on a computing device 116A. The client 102 operates in conjunction with a group conversation service 104 (which might be referred to herein as the “group conversation application 104”) to enable members of a group to converse (i.e. engage in a group conversation 108).

The group conversation 108 can be between users 106A and 106B, and others not shown in FIG. 1A, by way of the respective computing devices 116A and 116B. In one configuration, the group conversation service 104 is the SLACK group conversation service. Other group conversation services 104 from other sources can be utilized in other configurations.

The client 102 is a web browser application in one configuration, but can be implemented as a stand-alone application or as another type of application in other configurations. The client 102 communicates with a computing device 116C that provides the group conversation service 104 via a network 110, such as the internet. The group conversation service 104 (or another service) can maintain a datastore 120 that includes the group conversation 108 and, as will be described in greater detail below, a summary 114 of the group conversation 108 and related information.

In one configuration, a plug-in 118 to the group conversation service 104 is utilized to provide at least some of the functionality disclosed herein, including the provision of a human-machine interface 112 for collaborative summarization of group conversations 108. The plug-in 118 is implemented as a SLACK application (also commonly referred to as a “SLACK bot” or a “chat bot”) that can be installed for use by any organization that uses the SLACK group conversation service 104 in one configuration.

The plug-in 118 can be built on top of the MICROSOFT BOT FRAMEWORK, a software development kit (“SDK”) that enables development of chatbots for several applications at once, and the SLACK application programming interface (“API”). The plug-in 118 also utilizes a backend server (not shown in FIG. 1) in some configurations to store the summary 114 and, potentially, other types of data. The software components executing on the backend server are built in NODE.JS and interface with a MONGODB database in one implementation.

It should be appreciated that the disclosed technologies can also be implemented with other group conversation services 104, such as the HIPCHAT, internet relay chat (“IRC”), and GOOGLE HANGOUTS CHAT group conversation services. The disclosed technologies can also be used in other environments where group conversations take place including, but not limited to, email, social networking sites, transcribed audio recordings of group conversations, and others.

As will be described in greater detail below, in one configuration the plug-in 118 and the client 102 enable participants (e.g. the users 106A and 106B) in a group conversation 108 to label excerpts, such as messages, of the group conversation 108 with discourse act notes 122 (which might also be referred to herein as “tags,” “notes,” or “annotations”). For instance, and as shown in FIG. 1B and described in detail below, user input can be received from a user 106, such as a sequence of keystrokes or the selection of a graphic image, via the human-machine interface 112 that labels an excerpt 124 of the group conversation 108 with one or more discourse act notes 122. The human-machine interface 112 is a graphical user interface (“GUI”) in one configuration but, as described in greater detail below, other types of human-machine interfaces can be utilized in other configurations.

As described briefly above, a discourse act note 122 specifies the type of discourse taking place between participants in a group conversation 108 within an excerpt 124 of the group conversation 108. An excerpt 124 of a group conversation 108 is a continuous block of the conversation defined by a specified start and end. For example, and without limitation, a discourse act note 122A can indicate that an excerpt 124A (e.g. a sentence or paragraph) of a group conversation 108 includes a question. Another discourse act note 122B can indicate that an excerpt 124B of the group conversation 108 includes an answer to the previously-posed question. The discourse act notes 122 can be provided by a user while the user is participating in the group conversation 108 or after the group conversation 108 has ended. Other types of discourse act notes 122 can be specified in other configurations.

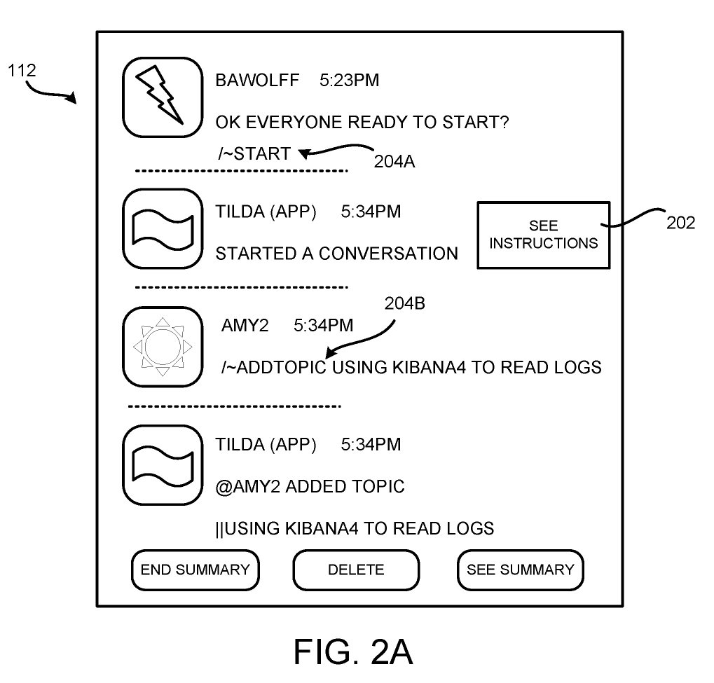

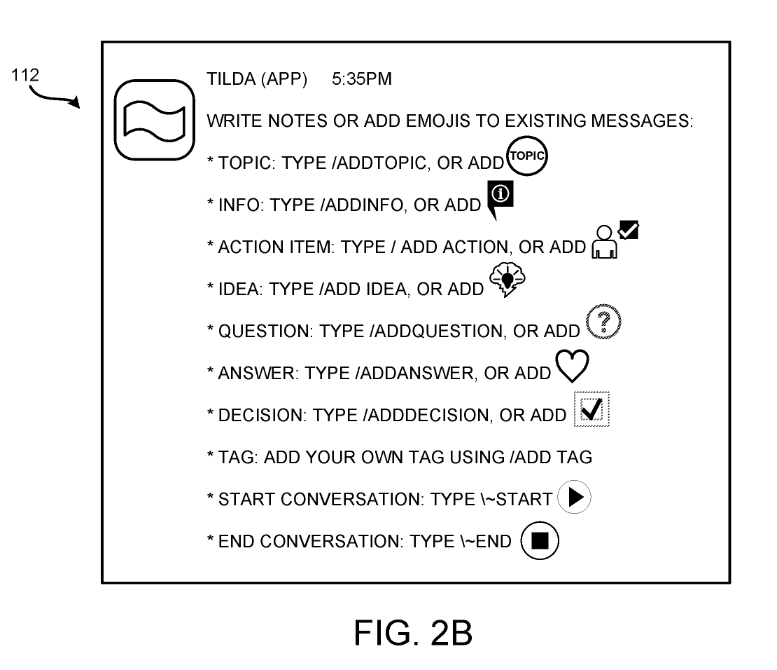

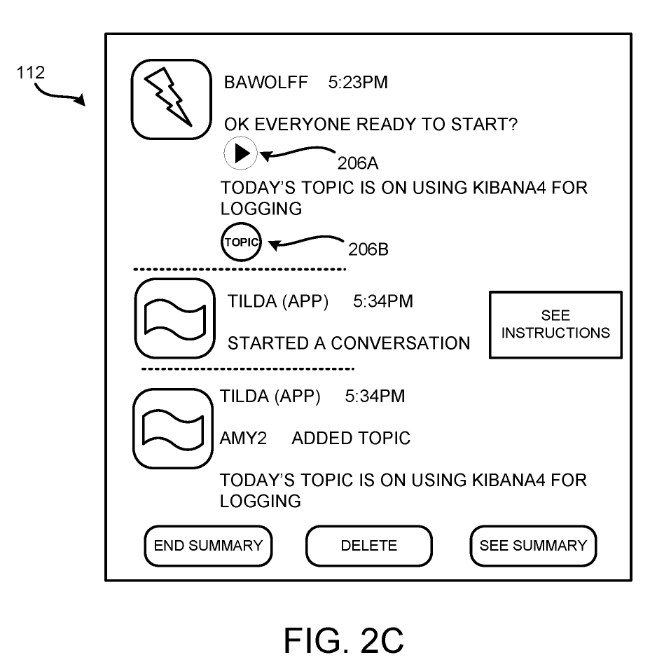

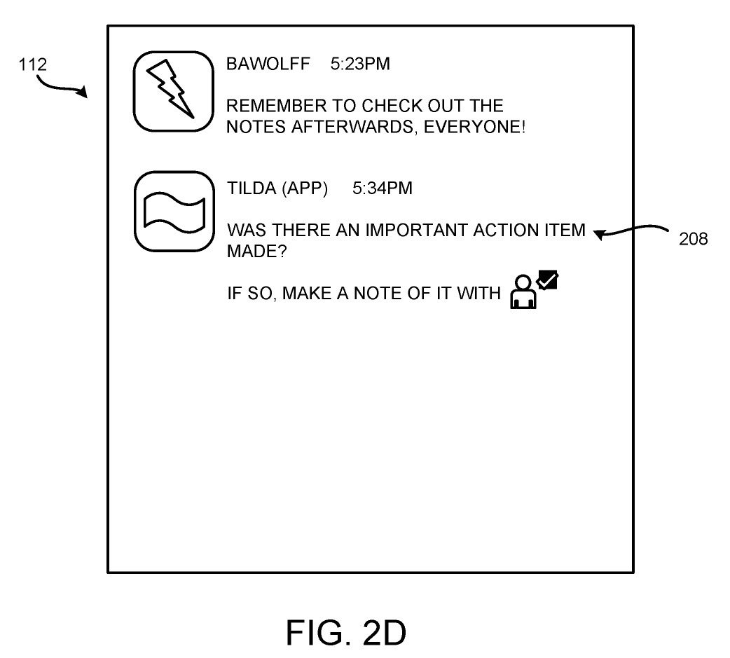

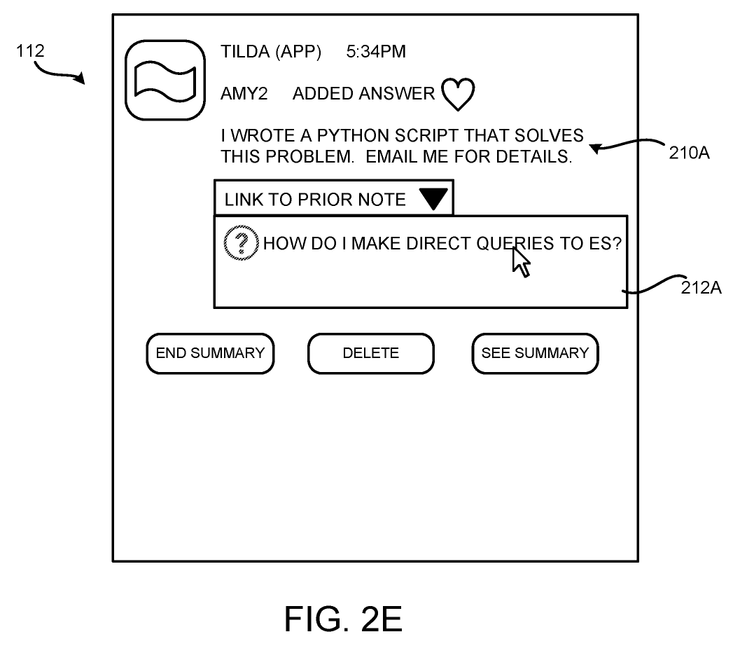

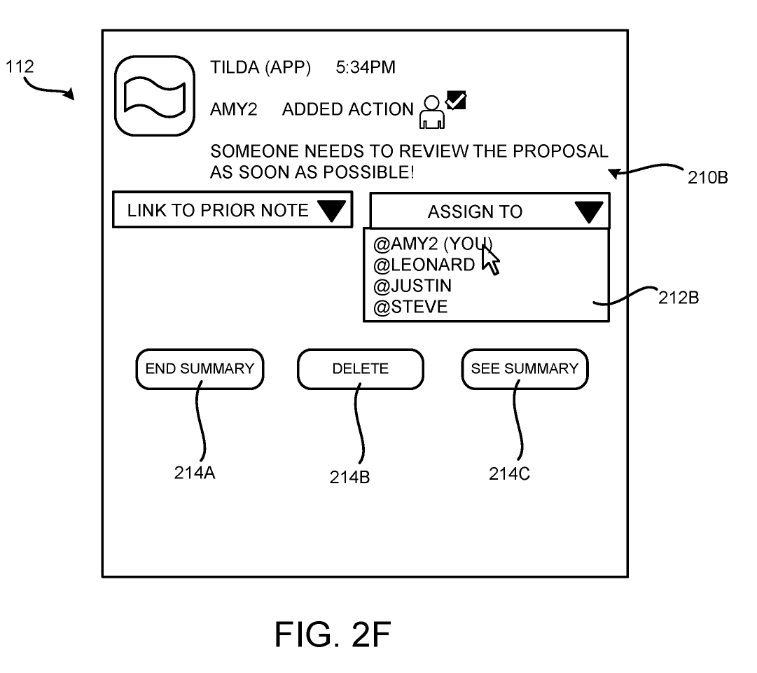

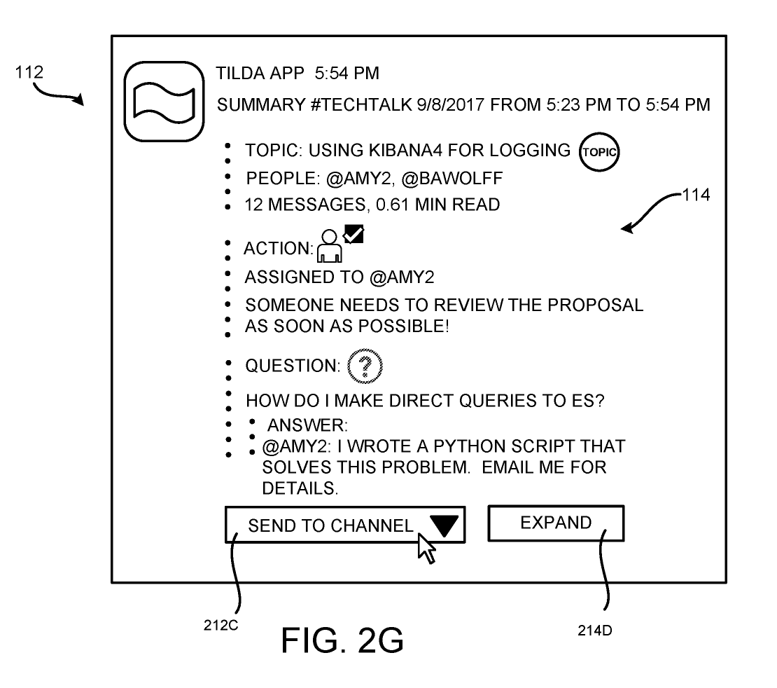

Discourse act notes 122 can be added to a group conversation 108 in several ways. First, and as shown in FIG. 2A, a user 106 can add discourse act notes 122 during the group conversation 108 using predefined commands that are recognized by the plug-in 118 as specifying discourse act notes 122. For example, and without limitation, “slash commands” can be utilized to specify discourse act notes 122 when the technologies disclosed herein are implemented with the SLACK group conversation service.

Slash commands can be invoked in the human-machine interface 112 by prepending a slash character (i.e. “/”) to the command. Discourse act notes 122 are further prepended with a tilde (i.e. “˜”) in one configuration so that a slash command can be recognized as a discourse act note 122. In this configuration, a group conversation 108 participant can type “/˜” followed by the discourse act note 122 to label an excerpt 124 of a group conversation 108 with a discourse act note 122.

As will be discussed in greater detail below, the discourse act notes 122 can be utilized to generate a summary 114 of a group conversation 108. Other types of slash commands, or actions, can also be provided such as, for instance, for signifying the start and end of a conversation 108 and for specifying the topic of the group conversation 108.

In the example shown in FIG. 2A, for instance, a participant in a group conversation 108 (BAWOLFF) has typed a message in the group conversation 108 asking if the participants in the group conversation 108 are ready to start. Following the display of that message, the participant has typed a slash command 204A indicating the start of the group conversation 108. In one configuration, only discourse act notes 122 specified for messages received between a start and an end action will be included in the summary 114 described below.

Following entry of the slash command 204A, the plug-in 118 has provided a confirmation in the group conversation 108 that the summarization process described herein has been started. The plug-in 118 has also caused a UI control 202 to be presented which, when selected, will provide instructions such as those shown in FIG. 2B for labeling a group conversation 108 with discourse act notes 122. In one configuration, a list of the available slash commands can also be viewed by typing “/˜”.

Following confirmation by the plug-in 118 that a conversation has started, another participant (AMY2) has supplied a slash command 204B indicating that a new topic of discussion has begun in the group conversation. The slash command 204B also provides a topic sentence that describes the topic of the group conversation 108. Following entry of the slash command 204B, the plug-in 118 has provided a confirmation in the group conversation 108 that a new topic has been added.

It is to be appreciated that an excerpt 122 of a group conversation 108 can be labeled with a discourse act note 122 prior to or following receipt of the excerpt 122. As an example, a discourse act note 122 for labeling an excerpt 122 of a group conversation 108 as defining a question can be received prior to the question being asked in the conversation 108. Another discourse act note 122 can be received after the excerpt 120 or conversation 108 has concluded that labels an excerpt 122 as a question.

In one configuration, there are five types of discourse act notes 122 that a user 106 can add in a group conversation. FIG. 2B and Table 1, below, show a list of possible discourse act notes 122 and their corresponding commands in this configuration. Other types of discourse act notes 122 can also be specified in a similar manner.

Table 1 also shows commands for defining the start and end of an excerpt of a group conversation 108. Together, the timestamps of the specified start and end mark a continuous block of a group conversation 108 (which might be referred to herein as an “excerpt”). Commands are also provided for specifying a topic for a conversation for tagging excerpts of a group conversation 108 with one or more custom discourse act notes 122, selecting one of any prior tags in a channel, or devising a new one, using the “\tilde{\}addtag” slash command. A user can add a discourse act note 122 either using the command approach, described above, or using graphic images, which will be described in detail below.

Discourse act notes 122 can also be added during or after a group conversation 108 using graphic images (e.g. an emoji or another type of image) to mark up messages in the group conversation 108. Participants can use this mechanism to annotate an existing excerpt by reviewing a log of the group conversation 108, thereby creating an extractive discourse act note 122 taken directly from the group conversation 108. Examples of several graphic images corresponding to discourse act notes 122 in one configuration are illustrated in FIG. 2B and Table 1, above. In some configurations, the group conversation service 104 also enables participants to specify custom graphic images for the discourse act notes 122, including uploading new images and renaming existing images.

In the example shown in FIG. 2C, for instance, a user (BAWOLFF) has typed the phrase “OK EVERYONE READY TO START” into a group conversation 108. The user then typed the phrase “TODAY'S TOPIC IS ON USING KIBANA4 FOR LOGGING.” Following the entry of these phrases, another user (AMY2) marked the phrase “OK EVERYONE READY TO START” with a graphic image 206A corresponding to the “\˜start” slash command, thereby indicating that the phrase is to be considered the start of the conversation. In this example, the user (AMY2) also marked the phrase “TODAY'S TOPIC IS ON USING KIBANA4 FOR LOGGING” with a graphic image 206B corresponding to the “\˜topic” slash command, thereby indicating that the phrase is to be used as the topic of the conversation. The plug-in 118 responds with confirmations that the conversation has been started and that the topic for the conversation has been set. Other graphic images can be utilized to associate discourse act notes 122 with excerpts of a group conversation 108 in a similar manner.

In one configuration, a user can tag an excerpt of a group conversation 108 with a graphic image 206 by first hovering a mouse cursor over the excerpt. When the mouse cursor is hovered over the excerpt, a UI control (not shown in FIG. 1) will be presented adjacent to the excerpt showing the available graphic images 206 that can be associated with the excerpt. When the user selects one of the graphic images 206, the selected graphic image 206, and its associated discourse act note 122, will be associated with the excerpt. Other types of user input devices and other UI arrangements can be utilized to associate a graphic image 206 with an excerpt of a group conversation 108 in other configurations.

In some configuration, the plug-in 118 can proactively post messages to a group conversation 108 when it identifies certain activities, as seen in FIG. 2D. For example, if a participant in a group conversation 108 indicates a like for a recent message in the group conversation 108, the plug-in 118 can post a suggestion publicly in the group conversation 108 to make a note of it. In another example, phrases can also be associated with discourse act type based off group conversations 108, such as “remember to” with “Action” as shown in FIG. 2D. When the plug-in 118 sees such a phrase, it posts a suggestion to the group conversation 108 to label the phrase with the corresponding discourse act note 122.

After a discourse act note 122 has been posted to a group conversation 108, the plug-in 118 can post a message 210A to the group conversation 108 that enables follow-up actions such as, but not limited to, linking the discourse act note 122 to a prior discourse act note 122, as shown in FIG. 2E. This can be used, for example, when it is desirable for a discourse act note 122 to be viewed in context with another discourse act note 122. For instance, an “answer” discourse act note 122 could be linked to its corresponding “question” discourse act note 122.

In one configuration, linking of discourse act notes 122 in a group conversation 108 is facilitated by a dropdown menu 212A presented by the human-machine interface 112. The dropdown menu 212A can provide a list of previous discourse act notes 122 to which a note can be linked. In the example shown in FIG. 2E, for instance, a link is being created between a discourse act note 122 that provides an answer (“I wrote a Python script that solves this problem . . . ” to a previously created discourse act note 122 that poses a question (“How do I make direct queries . . . ”). Other types of discourse act notes 122 can be linked in a similar fashion. In other configurations, the dropdown menu 212A or another portion of the human-machine interface 112 can expose functionality for filtering the discourse act notes 122 that are available for linking, changing a link between discourse act notes 122, deleting a link, or deleting a discourse act note 122. Other types of functionality can be provided in other configurations.

For discourse act notes 122 that specify an action, participants in a group conversation 108 can assign the action item specified by the discourse act note 122 to another participant in the group conversation 108. As with the linking of discourse act notes 122 described above with regard to FIG. 2E, functionality for assigning an action item based on a discourse act note 122 can be exposed through a dropdown menu in some configurations.

For instance, in the example shown in FIG. 2F, a user has added a message 210B and associated discourse act note 122 that specifies an action (“Someone needs to review the proposal . . . ”). Following the addition of the action discourse act note 122, a dropdown menu 212B can be presented that includes a list of participants 106 in the group conversation 108. One or more participants 106 in the group conversation 108 can then be selected from the list. In response thereto, the action specified by the message 210B will be assigned to the selected user, or users. Functionality can also be provided for re-assigning an action item to another participant 106, or participants 106, or removing the assignment altogether. Other types of functionality can be provided in other configurations.

As mentioned briefly above, at any point during a group conversation 108, participants can go back to edit an existing discourse act note 122, delete a discourse act note 122 (i.e. by selecting the UI control 214B), or add a new discourse act note 122 by assigning a graphic image 206 to an excerpt 124 of the group conversation 108 in the manner described above with reference to FIG. 2C. Participants 106 can also separate discourse act notes 122 into different groups corresponding to different group conversations 108, using the start and end commands or corresponding graphic images discussed above.

As also discussed briefly above, when a participant in a group conversation 108 labels an excerpt 124 of the group conversation 108 with an associated discourse act note 122, the discourse act note 122 and excerpt 124 are added to a running summary 114 of the group conversation 108. Excerpts 124 of the group conversation 108 that have been labeled with discourse act notes 122 are collected and grouped in the summary 114 by discourse act. The summary 114 can be presented directly in the group conversation 108 (i.e. in the human-machine interface) or in another location. The excerpts 124 of the group conversation 108 presented in the summary 114 can be grouped by discourse act. Discourse act notes 122 in the summary 114 can also be linked to their proper place in the original group conversation 108.

As discussed above, at any point while conversing, a participant 106 may choose to start annotating discourse acts with the plug-in 118 by invoking the start command discussed above, or by adding a discourse act note 122, which instructs the plug-in 118 to begin a new group conversation 108. At some point, a participant 106 may choose to end the current set of discourse act notes 122 because a group discussion 108 about a certain topic is over, or because the topic has shifted to a new discussion. In some configurations, the plug-in 118 can end any ongoing group conversation 108 if there is no activity for a predetermined number of minutes. Participants 106 can undo the ending of a group conversation 108 by the plug-in 118 and continue adding discourse act notes 122 to the existing group conversation 108 if it was ended prematurely.

An illustrative summary 114 is presented in FIG. 2G. As shown in FIG. 2G, high-level signals can be provided in the summary 114, such as information identifying the number of messages generated during a group conversation 108 and estimated read time, top participants, and any tags or topics that participants 106 have added to the group conversation 108.

The discourse act notes 122 that users 106 have added can also be displayed. In some configurations, the discourse act notes 122 are grouped by their discourse act type. The discourse act notes 122 within a discourse act type can be ordered chronologically, except for discourse act notes 122 that have been linked to other discourse act notes 122. If a discourse act note 122 has been linked to a parent discourse act note 122, it can be presented below that discourse act note 122 and indented to the right in some configurations. Discourse act notes 122 that are linked to an indented discourse act note 122 can be presented beneath that discourse act note 122.

Discourse act notes 122 in the summary 114 can be preceded by a hyperlink pointing to the original discourse act note 122 in the group conversation 108. This is possible because the discourse act note 122, whether it be extractive or abstractive, is embedded in the original group discussion 108. Thus, a summary 114, unlike typical notes taken in text documents, can be seen as an overlay on top of the original group discussion 108 and a jumping-off point for diving back into the log of the group discussion 108. Together with the ability to expand from smaller to larger summaries 114, this configuration provides efficient hierarchical exploration to users that can result in at least some of the technical benefits mentioned above.

Because participants 106 may define many discourse act notes 122 in a single group discussion 108, the human-machine interface 112 can be configured to show only a subset of the notes in the summary 114 with the ability to expand to see all notes. In one configuration an initial view is presented in the summary 114 that shows at most two (or some other number) discourse act notes 122, prioritizing discourse acts such as “decision” and “action” over “idea” and “info,” and showing at most two notes (or some other number) within a discourse act, prioritizing earlier discourse act notes 122. In order to expand the summary 114, users 106 can select the UI control 214D in some configurations. Upon expanding the summary 114, users 106 have the option of viewing notes in chronological order, grouped by discourse act, or in another manner.

Once a group conversation 108 has concluded, either through a user action or automatically by the plug-in 118, the summary 114 can be posted to places designated by the users 106. Users 106 can also specify where summaries 114 should be delivered. One way is through “following” the summaries 114 of a “channel” hosting a group conversation 108. A user 106 can, in another public or private channel, set that space to follow the summaries of a public channel using the slash command “\tilde{\}followchannel #channelname” in one configuration. From then on, all summaries 114 generated in the original channel will get posted to its designated places. Thus, one potential way to use plug-in 118 is to create one or more “summaries” channels that follow the summaries 114 of a subset or all discussion channels. Users 106 can then treat a summary channel as a public log of group conversation activity.

A second way summaries 114 can be delivered is by following channels within a user's direct message space with plug-in 118. To allow for personalization, users 106 can specify additional parameters in the “\˜followchannel” command to limit summaries 114 to only those identifying a particular participant or including a particular tag. Finally, the summary 114 can also be posted to the current channel. At that point, users 106 have the ability to manually send the summary 114 to a public channel using a dropdown menu 212C, as shown in FIG. 2G, or another type of UI control.

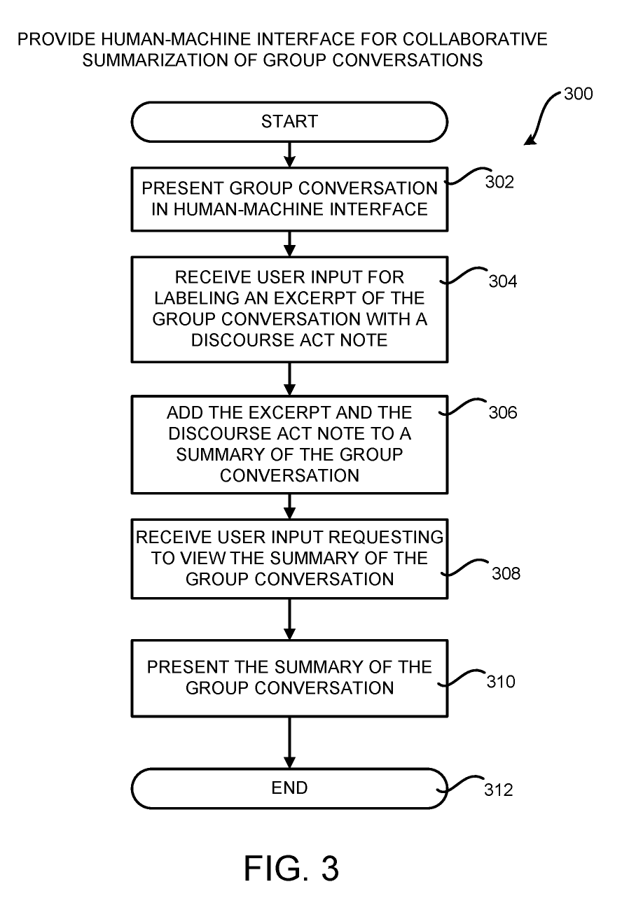

FIG. 3 is a flow diagram showing a routine 300 that illustrates aspects of the operation of the computing devices 116 shown in FIG. 1 for providing an improved human-machine interface 112 for collaborative summarization of group conversations 108, according to one configuration disclosed herein. It should be appreciated that the logical operations described herein with regard to FIG. 3 and the other FIGS. can be implemented (1) as a sequence of computer implemented acts or program modules running on a computing system and/or (2) as interconnected machine logic circuits or circuit modules within the computing system.

The particular implementation of the technologies disclosed herein is a matter of choice dependent on the performance and other requirements of the computing system. Accordingly, the logical operations described herein are referred to variously as states, operations, structural devices, acts, or modules. These states, operations, structural devices, acts and modules can be implemented in software, in firmware, in special purpose digital logic, and any combination thereof. It should also be appreciated that more or fewer operations can be performed than shown in the FIGS. and described herein. These operations can also be performed in a different order than those described herein.

The routine 300 begins at operation 302, where the human-machine interface 112 presents the group conversation 108. From operation 302, the routine 300 proceeds to operation 304, where user input, such as a sequence of keystrokes or the selection of a graphic image 206, is received via the human-machine interface 112 labeling an excerpt of the group conversation 108 with a discourse act note 122 corresponding to a discourse act. As discussed above, the discourse act note 122 can be specified prior to or following receipt of the excerpt of the group conversation.

From operation 304, the routine 300 proceeds to operation 306, where the excerpt 124 of the group conversation 108 and the specified discourse act note 122 are added to a summary 114 of the group conversation 108. At operation 308, user input is received requesting to view the summary 114 of the group conversation 108. In response thereto, the routine 300 proceeds to operation 310, where the summary 114 of the group conversation 108 is presented in the human-machine interface 112. The excerpts of the group conversation 108 presented in the summary 114 of the group conversation 108 can be grouped by corresponding discourse acts or in another manner.

As discussed above, the summary 114 of a group conversation 108 can also be edited, referenced, or sent to a second group conversation using the human-machine interface 112. UI controls can also be provided in the human-machine interface 112 for allowing a user 106 to subscribe to receive summaries associated with a channel, subscribe to summaries from a participant in a channel, or subscribe to summaries associated with a topic. The routine 300 proceeds from operation 310 to operation 312, where it ends.

It is to be appreciated that while the human-machine interface has been primarily described herein as a GUI, other types of human-machine interfaces can be used in other configurations. For example, and without limitation, a voice-driven interface could be utilized with the technologies disclosed herein to annotate group voice conversations with discourse act notes and to provide a summary of the discourse act notes in the manner described above. Other types of human-machine interfaces can be utilized in other configurations.

It is also to be appreciated that while the human-machine interface disclosed herein has been presented with reference to particular GUI controls (e.g. dropdown menus) and arrangements of GUI controls, other GUI controls and arrangements of GUI controls can be utilized in other configurations. These GUI controls and arrangements of GUI controls can be customized for the particular type of device with which the technologies disclosed herein are utilized (e.g. desktop computer, tablet, or smartphone).

It is to be further appreciated that while various configurations disclosed herein have been described with reference to the SLACK group conversation service and its associated slash commands, the technologies disclosed herein can be utilized with other types of group conversation services, including group conversation services from GOOGLE INC., FACEBOOK, INC., email, IRC, and other similar services.

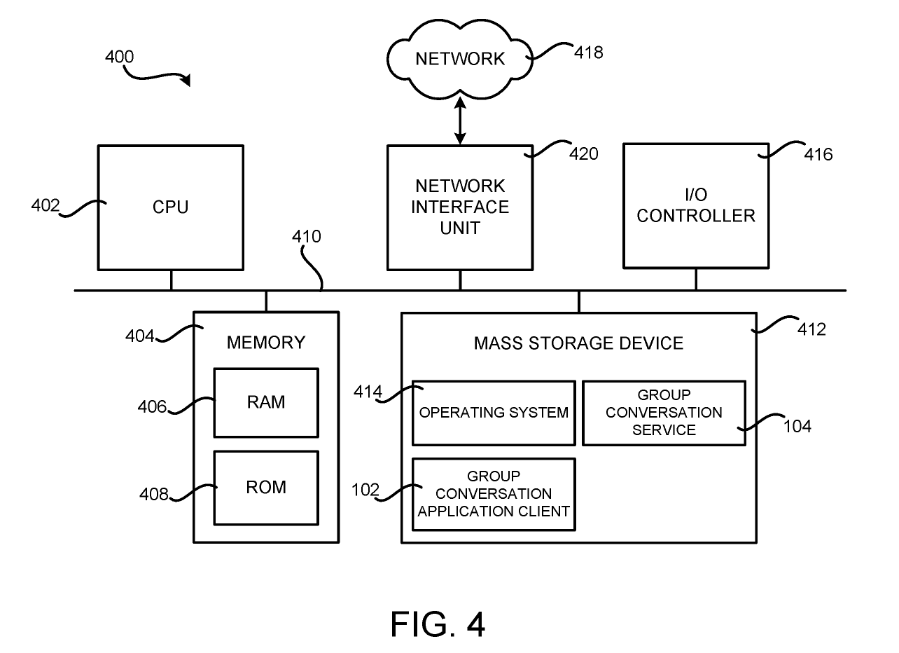

FIG. 4 is a computer architecture diagram that shows an architecture for a computer 400 capable of executing the software components described herein. The architecture illustrated in FIG. 4 is an architecture for a server computer, a mobile phone, an e-reader, a smart phone, a desktop computer, a netbook computer, a tablet computer, a laptop computer, or another type of computing device suitable for executing the software components presented herein.

In this regard, it should be appreciated that the computer 400 shown in FIG. 4 can be utilized to implement a computing device capable of executing any of the software components presented herein. For example, and without limitation, the computing architecture described with reference to the computer 400 can be utilized to implement the computing devices 116A-116C, illustrated in FIG. 1 and described above, which are capable of executing the group conversation service 104, the group conversation application client 102, and/or any of the other software components described above.

The computer 400 illustrated in FIG. 4 includes a central processing unit 402 (“CPU”), a system memory 404, including a random-access memory 406 (“RAM”) and a read-only memory (“ROM”) 408, and a system bus 410 that couples the memory 404 to the CPU 402. A basic input/output system containing the basic routines that help to transfer information between elements within the computer 400, such as during startup, is stored in the ROM 408. The computer 400 further includes a mass storage device 412 for storing an operating system 414 and one or more programs including, but not limited to, the group conversation service 104 or the group conversation application client 102. The mass storage device 412 can also be configured to store other types of programs and data.

The mass storage device 412 is connected to the CPU 402 through a mass storage controller (not shown) connected to the bus 410. The mass storage device 412 and its associated computer readable media provide non-volatile storage for the computer 400. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 400. For purposes of the claims, the phrase “computer storage medium,” and variations thereof, does not include waves or signals per se or communication media.

According to various configurations, the computer 400 can operate in a networked environment using logical connections to remote computers through a network such as the network 418. The computer 400 can connect to the network 418 through a network interface unit 420 connected to the bus 410. It should be appreciated that the network interface unit 420 can also be utilized to connect to other types of networks and remote computer systems. The computer 400 can also include an input/output controller 416 for receiving and processing input from a number of other devices, including a keyboard, mouse, touch input, or electronic stylus (not shown in FIG. 4). Similarly, the input/output controller 416 can provide output to a display screen, a printer, or other type of output device (also not shown in FIG. 4).

It should be appreciated that the software components described herein, such as the group conversation service 104, the group conversation application client 102, or the plug-in 118 can, when loaded into the CPU 402 and executed, transform the CPU 402 and the overall computer 400 from a general-purpose computing system into a special-purpose computing system customized to facilitate the functionality presented herein. The CPU 402 can be constructed from any number of transistors or other discrete circuit elements, which can individually or collectively assume any number of states. More specifically, the CPU 402 can operate as a finite-state machine, in response to executable instructions contained within the software modules disclosed herein. These computer-executable instructions can transform the CPU 402 by specifying how the CPU 402 transitions between states, thereby transforming the transistors or other discrete hardware elements constituting the CPU 402.

Encoding the software modules presented herein, such as the group conversation application client 102, the group conversation service 104, and the plug-in 118, can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 400 in order to store and execute the software components presented herein. It also should be appreciated that the architecture shown in FIG. 4 for the computer 400, or a similar architecture, can be utilized to implement other types of computing devices, including hand-held computers, embedded computer systems, mobile devices such as smartphones and tablets, and other types of computing devices known to those skilled in the art. It is also contemplated that the computer 400 might not include all of the components shown in FIG. 4, can include other components that are not explicitly shown in FIG. 4, or can utilize an architecture completely different than that shown in FIG. 4.

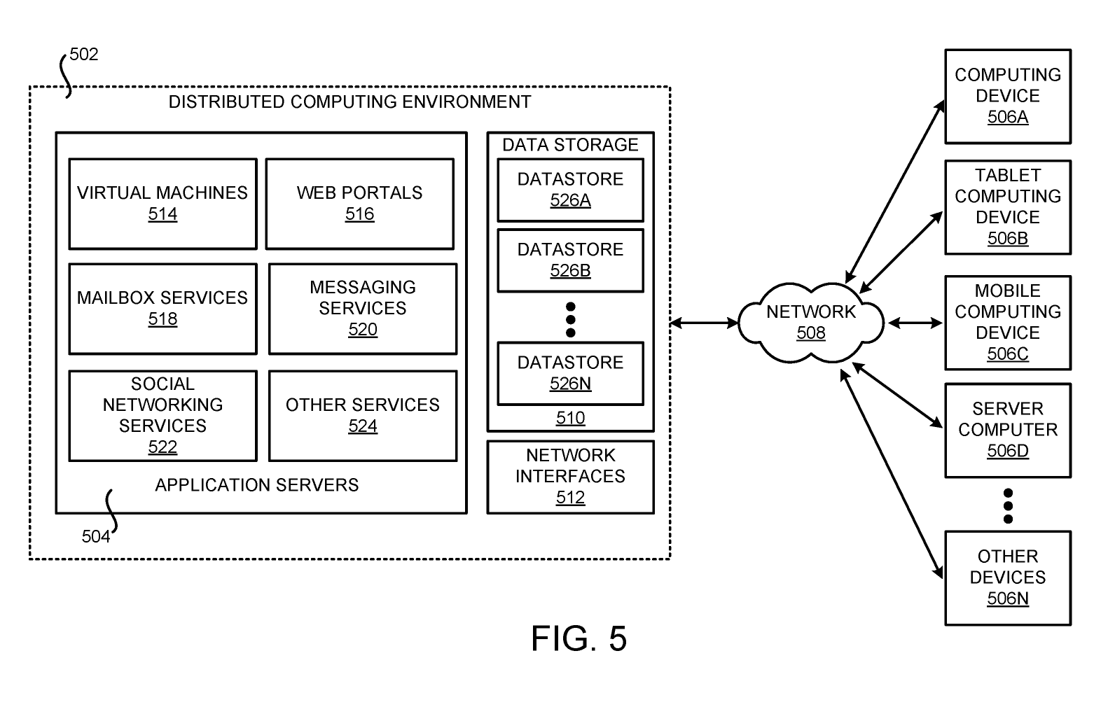

FIG. 5 shows aspects of an illustrative distributed computing environment 502 in which the software components described herein can be executed. Thus, the distributed computing environment 502 illustrated in FIG. 5 can be used to execute program code, such as the group conversation service 104, capable of providing the functionality described herein with respect to FIGS. 1-3, and/or any of the other software components described herein.

According to various implementations, the distributed computing environment 502 operates on, in communication with, or as part of a network 508. One or more client devices 506A-506N (hereinafter referred to collectively and/or generically as “clients 506”) can communicate with the distributed computing environment 502 via the network 508 and/or other connections (not illustrated in FIG. 5).

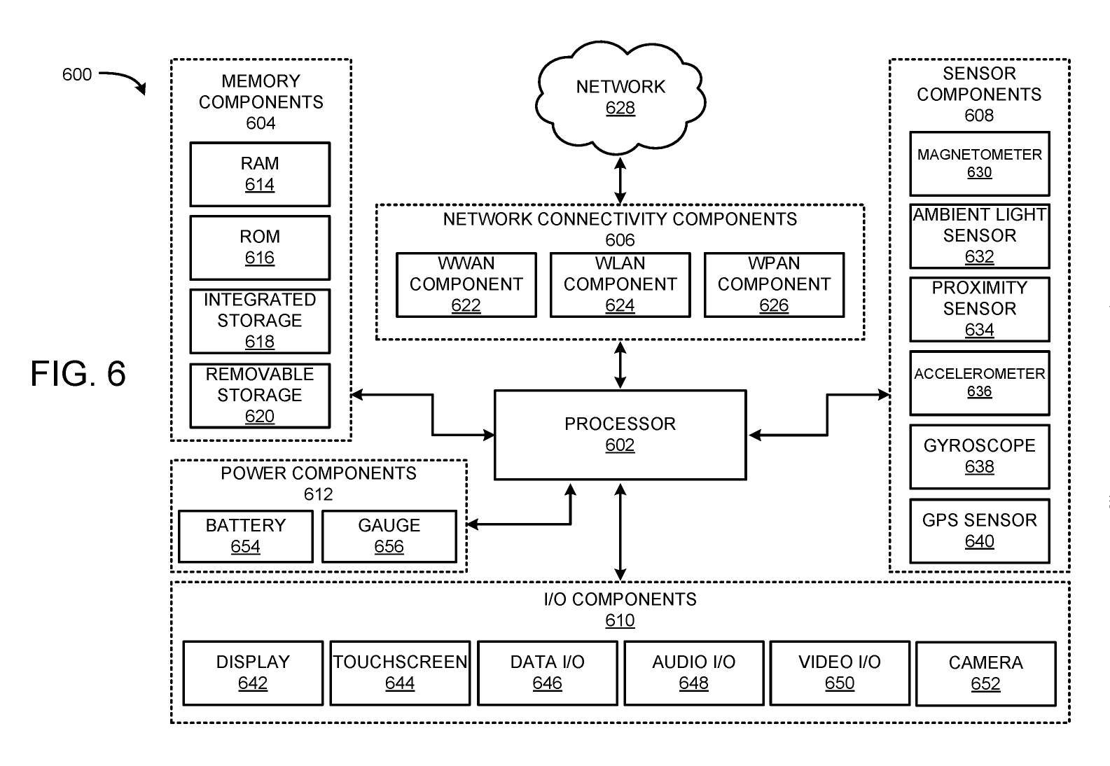

In the illustrated configuration, the clients 506 include: a computing device 506A such as a laptop computer, a desktop computer, or other computing device; a “slate” or tablet computing device (“tablet computing device”) 506B; a mobile computing device 506C such as a mobile telephone, a smart phone, or other mobile computing device; a server computer 506D; and/or other devices 506N. It should be understood that any number of clients 506 can communicate with the distributed computing environment 502. Two example computing architectures for the clients 506 are illustrated and described herein with reference to FIGS. 4 and 6. It should be understood that the illustrated clients 506 and computing architectures illustrated and described herein are illustrative, and should not be construed as being limited in any way.

In the illustrated configuration, the distributed computing environment 502 includes application servers 504, data storage 510, and one or more network interfaces 512. According to various implementations, the functionality of the application servers 504 can be provided by one or more server computers that are executing as part of, or in communication with, the network 508. The application servers 504 can host various services such as the group conversation service 104 described above, virtual machines, portals, and/or other resources. In the illustrated configuration, the application servers 504 host one or more virtual machines 514 for hosting applications, such as the group conversation service 104, or other functionality. According to various implementations, the virtual machines 514 host one or more applications and/or software modules, such as the group conversation service 104. It should be understood that this configuration is illustrative, and should not be construed as being limiting in any way. The application servers 504 might also host or provide access to one or more Web portals, link pages, Web sites, and/or other information (“Web portals”) 516.

According to various implementations, the application servers 504 also include one or more mailbox services 518 and one or more messaging services 520. The mailbox services 518 can include electronic mail (“email”) services. The mailbox services 518 can also include various personal information management (“PIM”) services including, but not limited to, calendar services, contact management services, collaboration services, and/or other services. The messaging services 520 can include, but are not limited to, instant messaging (“IM”) services, chat services, forum services, and/or other communication services.

The application servers 504 can also include one or more social networking services 522. The social networking services 522 can provide various types of social networking services including, but not limited to, services for sharing or posting status updates, instant messages, links, photos, videos, and/or other information, services for commenting or displaying interest in articles, products, blogs, or other resources, and/or other services. In some configurations, the social networking services 522 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 522 are provided by other services, sites, and/or providers that might be referred to as “social networking providers.” For example, some Web sites allow users to interact with one another via email, group conversation services, and/or other means during various activities and/or contexts such as reading published articles, commenting on goods or services, publishing, collaboration, gaming, and the like. Other services are possible and are contemplated.

The social network services 522 can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 522 are not mentioned herein for the sake of brevity. As such, the configurations described above are illustrative, and should not be construed as being limited in any way.

As also shown in FIG. 5, the application servers 504 can also host other services, applications, portals, and/or other resources (“other services”) 524. The other services 524 can include, but are not limited to, the group conversation service 104, and/or any of the other software components described herein. The group conversation services can include, but are not limited to, SLACK, HIPCHAT, IRC, and GOOGLE HANGOUTS CHAT. It thus can be appreciated that the distributed computing environment 502 can provide integration of the technologies disclosed herein with various mailbox, messaging, social networking, group conversation, productivity, or other types of services or resources.

As mentioned above, the distributed computing environment 502 can include data storage 510. According to various implementations, the functionality of the data storage 510 is provided by one or more databases operating on, or in communication with, the network 508. The functionality of the data storage 510 can also be provided by one or more server computers configured to host data for the distributed computing environment 502. The data storage 510 can include, host, or provide one or more real or virtual datastores 526A-526N (hereinafter referred to collectively and/or generically as “datastores 526”). The datastores 526 are configured to host data used or created by the application servers 504 and/or other data.

The distributed computing environment 502 can communicate with, or be accessed by, the network interfaces 512. The network interfaces 512 can include various types of network hardware and software for supporting communications between two or more computing devices including, but not limited to, the clients 506 and the application servers 504. It should be appreciated that the network interfaces 512 can also be utilized to connect to other types of networks and/or computer systems.

It should be understood that the distributed computing environment 502 described herein can implement any aspects of the software elements described herein with any number of virtual computing resources and/or other distributed computing functionality that can be configured to execute any aspects of the software components disclosed herein. According to various implementations of the technologies disclosed herein, the distributed computing environment 502 provides some or all of the software functionality described herein as a service to the clients 506. It should be understood that the clients 506 can also include real or virtual machines including, but not limited to, server computers, Web servers, personal computers, mobile computing devices, smart phones, and/or other devices. As such, various implementations of the technologies disclosed herein enable any device configured to access the distributed computing environment 502 to utilize the functionality described herein.

Turning now to FIG. 6, an illustrative computing device architecture 600 will be described for a computing device, such as the computing devices 116, that is capable of executing the various software components described herein. The computing device architecture 600 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like.

The computing device architecture 600 is also applicable to any of the clients 506 shown in FIG. 5. Furthermore, aspects of the computing device architecture 600 are applicable to traditional desktop computers, portable computers (e.g., laptops, notebooks, ultra-portables, and netbooks), server computers, and other computer systems, such as described herein with reference to FIG. 6. For example, the single touch and multi-touch aspects disclosed herein below can be applied to desktop computers that utilize a touchscreen or some other touch-enabled device, such as a touch-enabled track pad or touch-enabled mouse. The computing device architecture 600 can also be utilized to implement the computing devices 116, and/or other types of computing devices for implementing or consuming the functionality described herein.

The computing device architecture 600 illustrated in FIG. 6 includes a processor 602, memory components 604, network connectivity components 606, sensor components 608, input/output components 610, and power components 612. In the illustrated configuration, the processor 602 is in communication with the memory components 604, the network connectivity components 606, the sensor components 608, the input/output (“I/O”) components 610, and the power components 612. Although no connections are shown between the individual components illustrated in FIG. 6, the components can be connected electrically in order to interact and carry out device functions. In some configurations, the components are arranged so as to communicate via one or more busses (not shown).

The processor 602 includes one or more central processing unit (“CPU”) cores configured to process data, execute computer-executable instructions of one or more application programs, such as the group conversation client application 102, and to communicate with other components of the computing device architecture 600 in order to perform various functionality described herein. The processor 602 can be utilized to execute aspects of the software components presented herein and, particularly, those that utilize, at least in part, a touch-enabled input.

In some configurations, the processor 602 includes a graphics processing unit (“GPU”) configured to accelerate operations performed by the CPU, including, but not limited to, operations performed by executing general-purpose scientific and engineering computing applications, as well as graphics-intensive computing applications such as high-resolution video (e.g., 720P, 1080P, 4K, and greater), video games, 3D modeling applications, and the like. In some configurations, the processor 602 is configured to communicate with a discrete GPU (not shown). In any case, the CPU and GPU can be configured in accordance with a co-processing CPU/GPU computing model, wherein the sequential part of an application executes on the CPU and the computationally intensive part is accelerated by the GPU.

In some configurations, the processor 602 is, or is included in, a system-on-chip (“SoC”) along with one or more of the other components described herein below. For example, the SoC can include the processor 602, a GPU, one or more of the network connectivity components 606, and one or more of the sensor components 608. In some configurations, the processor 602 is fabricated, in part, utilizing a package-on-package (“PoP”) integrated circuit packaging technique. Moreover, the processor 602 can be a single core or multi-core processor.

The processor 602 can be created in accordance with an ARM architecture, available for license from ARM HOLDINGS of Cambridge, United Kingdom. Alternatively, the processor 602 can be created in accordance with an x86 architecture, such as is available from INTEL CORPORATION of Mountain View, Calif. and others. In some configurations, the processor 602 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 604 include a RAM 614, a ROM 616, an integrated storage memory (“integrated storage”) 618, and a removable storage memory (“removable storage”) 620. In some configurations, the RAM 614 or a portion thereof, the ROM 616 or a portion thereof, and/or some combination of the RAM 614 and the ROM 616 is integrated in the processor 602. In some configurations, the ROM 616 is configured to store a firmware, an operating system or a portion thereof (e.g., operating system kernel), and/or a bootloader to load an operating system kernel from the integrated storage 618 or the removable storage 620.

The integrated storage 618 can include a solid-state memory, a hard disk, or a combination of solid-state memory and a hard disk. The integrated storage 618 can be soldered or otherwise connected to a logic board upon which the processor 602 and other components described herein might also be connected. As such, the integrated storage 618 is integrated in the computing device. The integrated storage 618 can be configured to store an operating system or portions thereof, application programs, data, and other software components described herein.

The removable storage 620 can include a solid-state memory, a hard disk, or a combination of solid-state memory and a hard disk. In some configurations, the removable storage 620 is provided in lieu of the integrated storage 618. In other configurations, the removable storage 620 is provided as additional optional storage. In some configurations, the removable storage 620 is logically combined with the integrated storage 618 such that the total available storage is made available and shown to a user as a total combined capacity of the integrated storage 618 and the removable storage 620.

The removable storage 620 is configured to be inserted into a removable storage memory slot (not shown) or other mechanism by which the removable storage 620 is inserted and secured to facilitate a connection over which the removable storage 620 can communicate with other components of the computing device, such as the processor 602. The removable storage 620 can be embodied in various memory card formats including, but not limited to, PC card, COMPACTFLASH card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 604 can store an operating system. According to various configurations, the operating system includes, but is not limited to, the WINDOWS MOBILE OS, the WINDOWS PHONE OS, or the WINDOWS OS from MICROSOFT CORPORATION, BLACKBERRY OS from RESEARCH IN MOTION, LTD. of Waterloo, Ontario, Canada, IOS from APPLE INC. of Cupertino, Calif., and ANDROID OS from GOOGLE, INC. of Mountain View, Calif. Other operating systems are contemplated.

The network connectivity components 606 include a wireless wide area network component (“WWAN component”) 622, a wireless local area network component (“WLAN component”) 624, and a wireless personal area network component (“WPAN component”) 626. The network connectivity components 606 facilitate communications to and from a network 628, which can be a WWAN, a WLAN, or a WPAN. Although a single network 628 is illustrated, the network connectivity components 606 can facilitate simultaneous communication with multiple networks. For example, the network connectivity components 606 can facilitate simultaneous communications with multiple networks via one or more of a WWAN, a WLAN, or a WPAN.

The network 628 can be a WWAN, such as a mobile telecommunications network utilizing one or more mobile telecommunications technologies to provide voice and/or data services to a computing device utilizing the computing device architecture 600 via the WWAN component 622. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”).

Moreover, the network 628 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 628 can be configured to provide voice and/or data communications with any combination of the above technologies. The network 628 can be configured to or adapted to provide voice and/or data communications in accordance with future generation technologies.

In some configurations, the WWAN component 622 is configured to provide dual-multi-mode connectivity to the network 628. For example, the WWAN component 622 can be configured to provide connectivity to the network 628, wherein the network 628 provides service via GSM and UMTS technologies, or via some other combination of technologies. Alternatively, multiple WWAN components 622 can be utilized to perform such functionality, and/or provide additional functionality to support other non-compatible technologies (i.e., incapable of being supported by a single WWAN component). The WWAN component 622 can facilitate similar connectivity to multiple networks (e.g., a UMTS network and an LTE network).

The network 628 can be a WLAN operating in accordance with one or more Institute of Electrical and Electronic Engineers (“IEEE”) 104.11 standards, such as IEEE 104.11a, 104.11b, 104.11g, 104.11n, and/or a future 104.11 standard (referred to herein collectively as WI-FI). Draft 104.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 624 is configured to connect to the network 628 via the WI-FI access points. Such connections can be secured via various encryption technologies including, but not limited to, WI-FI Protected Access (“WPA”), WPA2, Wired Equivalent Privacy (“WEP”), and the like.

The network 628 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 626 is configured to facilitate communications with other devices, such as peripherals, computers, or other computing devices via the WPAN.

The sensor components 608 include a magnetometer 630, an ambient light sensor 632, a proximity sensor 634, an accelerometer 636, a gyroscope 638, and a Global Positioning System sensor (“GPS sensor”) 640. It is contemplated that other sensors, such as, but not limited to, temperature sensors or shock detection sensors, might also be incorporated in the computing device architecture 600.

The magnetometer 630 is configured to measure the strength and direction of a magnetic field. In some configurations, the magnetometer 630 provides measurements to a compass application program stored within one of the memory components 604 in order to provide a user with accurate directions in a frame of reference including the cardinal directions, north, south, east, and west. Similar measurements can be provided to a navigation application program that includes a compass component. Other uses of measurements obtained by the magnetometer 630 are contemplated.

The ambient light sensor 632 is configured to measure ambient light. In some configurations, the ambient light sensor 632 provides measurements to an application program stored within one the memory components 604 in order to automatically adjust the brightness of a display (described below) to compensate for low light and bright light environments. Other uses of measurements obtained by the ambient light sensor 632 are contemplated.

The proximity sensor 634 is configured to detect the presence of an object or thing in proximity to the computing device without direct contact. In some configurations, the proximity sensor 634 detects the presence of a user's body (e.g., the user's face) and provides this information to an application program stored within one of the memory components 604 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 634 are contemplated.

The accelerometer 636 is configured to measure proper acceleration. In some configurations, output from the accelerometer 636 is used by an application program as an input mechanism to control some functionality of the application program. In some configurations, output from the accelerometer 636 is provided to an application program for use in switching between landscape and portrait modes, calculating coordinate acceleration, or detecting a fall. Other uses of the accelerometer 636 are contemplated.

The gyroscope 638 is configured to measure and maintain orientation. In some configurations, output from the gyroscope 638 is used by an application program as an input mechanism to control some functionality of the application program. For example, the gyroscope 638 can be used for accurate recognition of movement within a 3D environment of a video game application or some other application. In some configurations, an application program utilizes output from the gyroscope 638 and the accelerometer 636 to enhance control of some functionality of the group conversation application client 102. Other uses of the gyroscope 638 are contemplated.

The GPS sensor 640 is configured to receive signals from GPS satellites for use in calculating a location. The location calculated by the GPS sensor 640 can be used by any application program that requires or benefits from location information. For example, the location calculated by the GPS sensor 640 can be used with a navigation application program to provide directions from the location to a destination or directions from the destination to the location. Moreover, the GPS sensor 640 can be used to provide location information to an external location-based service, such as E911 service. The GPS sensor 640 can obtain location information generated via WI-FI, WIMAX, and/or cellular triangulation techniques utilizing one or more of the network connectivity components 606 to aid the GPS sensor 640 in obtaining a location fix. The GPS sensor 640 can also be used in Assisted GPS (“A-GPS”) systems.

The I/O components 610 include a display 642, a touchscreen 644, a data I/O interface component (“data I/O”) 646, an audio I/O interface component (“audio I/O”) 648, a video I/O interface component (“video I/O”) 650, and a camera 652. In some configurations, the display 642 and the touchscreen 644 are combined. In some configurations two or more of the data I/O component 646, the audio I/O component 648, and the video I/O component 650 are combined. The I/O components 610 can include discrete processors configured to support the various interfaces described below, or might include processing functionality built-in to the processor 602.

The display 642 is an output device configured to present information in a visual form. In particular, the display 642 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 642 is a liquid crystal display (“LCD”) utilizing any active or passive matrix technology and any backlighting technology (if used). In some configurations, the display 642 is an organic light emitting diode (“OLED”) display. Other display types are contemplated.

The touchscreen 644 is an input device configured to detect the presence and location of a touch. The touchscreen 644 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 644 is incorporated on top of the display 642 as a transparent layer to enable a user to use one or more touches to interact with objects or other information presented on the display 642. In other configurations, the touchscreen 644 is a touch pad incorporated on a surface of the computing device that does not include the display 642. For example, the computing device can have a touchscreen incorporated on top of the display 642 and a touch pad on a surface opposite the display 642.

In some configurations, the touchscreen 644 is a single-touch touchscreen. In other configurations, the touchscreen 644 is a multi-touch touchscreen. In some configurations, the touchscreen 644 is configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 644. As such, a developer can create gestures that are specific to a particular application program.

In some configurations, the touchscreen 644 supports a tap gesture in which a user taps the touchscreen 644 once on an item presented on the display 642. The tap gesture can be used for various reasons including, but not limited to, opening or launching whatever the user taps, such as a graphic image representing the group conversation application client 102. In some configurations, the touchscreen 644 supports a double tap gesture in which a user taps the touchscreen 644 twice on an item presented on the display 642. The double tap gesture can be used for various reasons including, but not limited to, zooming in or zooming out in stages. In some configurations, the touchscreen 644 supports a tap and hold gesture in which a user taps the touchscreen 644 and maintains contact for at least a pre-defined time. The tap and hold gesture can be used for various reasons including, but not limited to, opening a context-specific menu.

In some configurations, the touchscreen 644 supports a pan gesture in which a user places a finger on the touchscreen 644 and maintains contact with the touchscreen 644 while moving the finger on the touchscreen 644. The pan gesture can be used for various reasons including, but not limited to, moving through screens, images, or menus at a controlled rate. Multiple finger pan gestures are also contemplated. In some configurations, the touchscreen 644 supports a flick gesture in which a user swipes a finger in the direction the user wants the screen to move. The flick gesture can be used for various reasons including, but not limited to, scrolling horizontally or vertically through menus or pages. In some configurations, the touchscreen 644 supports a pinch and stretch gesture in which a user makes a pinching motion with two fingers (e.g., thumb and forefinger) on the touchscreen 644 or moves the two fingers apart. The pinch and stretch gesture can be used for various reasons including, but not limited to, zooming gradually in or out of a website, map, or picture.

Although the gestures described above have been presented with reference to the use of one or more fingers for performing the gestures, other appendages such as toes or objects such as styluses can be used to interact with the touchscreen 644. As such, the above gestures should be understood as being illustrative and should not be construed as being limiting in any way.

The data I/O interface component 646 is configured to facilitate input of data to the computing device and output of data from the computing device. In some configurations, the data I/O interface component 646 includes a connector configured to provide wired connectivity between the computing device and a computer system, for example, for synchronization operation purposes. The connector can be a proprietary connector or a standardized connector such as USB, micro-USB, mini-USB, USB-C, or the like. In some configurations, the connector is a dock connector for docking the computing device with another device such as a docking station, audio device (e.g., a digital music player), or video device.

The audio I/O interface component 648 is configured to provide audio input and/or output capabilities to the computing device. In some configurations, the audio I/O interface component 648 includes a microphone configured to collect audio signals. In some configurations, the audio I/O interface component 648 includes a headphone jack configured to provide connectivity for headphones or other external speakers. In some configurations, the audio interface component 648 includes a speaker for the output of audio signals. In some configurations, the audio I/O interface component 648 includes an optical audio cable out.

The video I/O interface component 650 is configured to provide video input and/or output capabilities to the computing device. In some configurations, the video I/O interface component 650 includes a video connector configured to receive video as input from another device (e.g., a video media player such as a DVD or BLU-RAY player) or send video as output to another device (e.g., a monitor, a television, or some other external display). In some configurations, the video I/O interface component 650 includes a High-Definition Multimedia Interface (“HDMI”), mini-HDMI, micro-HDMI, DisplayPort, or proprietary connector to input/output video content. In some configurations, the video I/O interface component 650 or portions thereof is combined with the audio I/O interface component 648 or portions thereof.

The camera 652 can be configured to capture still images and/or video. The camera 652 can utilize a charge coupled device (“CCD”) or a complementary metal oxide semiconductor (“CMOS”) image sensor to capture images. In some configurations, the camera 652 includes a flash to aid in taking pictures in low-light environments. Settings for the camera 652 can be implemented as hardware or software buttons.

Although not illustrated, one or more hardware buttons can also be included in the computing device architecture 600. The hardware buttons can be used for controlling some operational aspect of the computing device. The hardware buttons can be dedicated buttons or multi-use buttons. The hardware buttons can be mechanical or sensor-based.

The illustrated power components 612 include one or more batteries 654, which can be connected to a battery gauge 656. The batteries 654 can be rechargeable or disposable. Rechargeable battery types include, but are not limited to, lithium polymer, lithium ion, nickel cadmium, and nickel metal hydride. The batteries 654 can be made of one or more cells.

The battery gauge 656 can be configured to measure battery parameters such as current, voltage, and temperature. In some configurations, the battery gauge 656 is configured to measure the effect of a battery's discharge rate, temperature, age and other factors to predict remaining life within a certain percentage of error. In some configurations, the battery gauge 656 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 612 can also include a power connector (not shown), which can be combined with one or more of the aforementioned I/O components 610. The power components 612 can interface with an external power system or charging equipment via a power I/O component. Other configurations can also be utilized.

Based on the foregoing, it should be appreciated that various technologies for providing an improved human-machine interface for collaborative summarization of group conversations have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method for providing a human-machine interface for collaborative summarization of a group conversation, the method comprising:
presenting the group conversation in the human-machine interface;
receiving first user input by way of the human-machine interface, the first user input comprising a request to label an excerpt of the group conversation with a discourse act note corresponding to a discourse act;
responsive to receiving the first user input, adding the excerpt and the discourse act note to a summary of the group conversation;
receiving second user input by way of the human-machine interface, the second user input comprising a request to view the summary of the group conversation; and
responsive to receiving the second user input, presenting the summary of the group conversation in the human-machine interface.

2. The computer-implemented method of claim 1, wherein the discourse act note indicates that the excerpt of the group conversation specifies an action, an answer, a decision, an idea, or a question.

3. The computer-implemented method of claim 1, wherein the first user input comprises a sequence of keystrokes corresponding to the discourse act note or selection of a graphic image corresponding to the discourse act note.

4. The computer-implemented method of claim 1, wherein the first user input is received prior to receiving the excerpt or following receipt of the excerpt.

5. The computer-implemented method of claim 1, wherein excerpts in the summary of the group conversation are grouped by a corresponding discourse act.

6. The computer-implemented method of claim 1, wherein the summary of the group conversation can be edited, referenced, or sent to a second group conversation using the human-machine interface.

7. The computer-implemented method of claim 1, further comprising:
receiving a third user input by way of the human-machine interface, the third user input for labeling a start of the group conversation; and
receiving a fourth user input by way of the human-machine interface, the fourth user input for labeling an end of the group conversation.

8. An apparatus, comprising:
one or more processors; and
at least one computer storage medium having computer executable instructions stored thereon which, when executed by the one or more processors, cause the apparatus to:
receive first user input by way of a human-machine interface, the first user input comprising a request to label an excerpt of a group conversation with a discourse act note;
responsive to receiving the first user input, adding the excerpt and the discourse act note to a summary of the group conversation;
receiving second user input by way of the human-machine interface, the second user input comprising a request to view the summary of the group conversation; and
responsive to receiving the second user input, present the summary of the group conversation in the human-machine interface.

9. The apparatus of claim 8, wherein the discourse act note indicates that the excerpt of the group conversation specifies an action, an answer, a decision, an idea, a custom discourse act, or a question.

10. The apparatus of claim 8, wherein the first user input comprises a sequence of keystrokes corresponding to the discourse act note or selection of a graphic image corresponding to the discourse act note.

11. The apparatus of claim 8, wherein the first user input is received following receipt of the excerpt.

12. The apparatus of claim 8, wherein excerpts in the summary of the group conversation are grouped by a corresponding discourse act.

13. The apparatus of claim 8, wherein the summary of the group conversation can be edited, referenced, or sent to a second group conversation using the human-machine interface.

14. The apparatus of claim 8, wherein the human-machine interface provides controls for allowing a user to subscribe to receive a summary of a group conversation associated with a channel, subscribe to receive a summary of a group conversation from a participant in the channel, or subscribe to receive a summary of a group conversation associated with a topic.

15. At least one computer storage medium having computer executable instructions stored thereon which, when executed by the one or more processors, cause the apparatus to:
receive first user input by way of a human-machine interface, the first user input comprising a request to tag an excerpt of a group conversation with a discourse act note corresponding to a discourse act;
adding the excerpt and the discourse act note to a summary of the group conversation;
receive a request to view the summary of the group conversation; and
present the summary of the group conversation in the human-machine interface.

16. The at least one computer storage medium of claim 15, wherein the discourse act note indicates that the excerpt of the group conversation specifies an action, an answer, a decision, an idea, or a question.

17. The at least one computer storage medium of claim 15, wherein the first user input comprises a sequence of keystrokes corresponding to the discourse act note or a selection of a graphic image corresponding to the discourse act note.

18. The at least one computer storage medium of claim 15, wherein excerpts in the summary of the group conversation are grouped by a corresponding discourse act.

19. The at least one computer storage medium of claim 15, wherein the summary of the group conversation can be edited, referenced, or sent to a second group conversation using the human-machine interface.

20. The at least one computer storage medium of claim 15, having further computer executable instructions stored thereon to:
receive third user input by way of the human-machine interface, the third user input labeling a start of the group conversation; and
receive fourth user input by way of the human-machine interface, the fourth user input labeling an end of the group conversation.
